(19) United States
(12) Patent Application Publication
(10) Pub. No.: US 2008/0239530 A1
(43) Pub. Date: Oct. 2, 2008

(54) Mirror pane with a substrate of plastic, a method for its manufacture and an external mirror having such a mirror pane

(76) Inventors: Werner Lang, Ergersheim (DE); Jochen Bauer, Ergersheim (DE); Willi Felbinger, Markt Nordheim (DE)

Correspondence Address: MCNAIR LAW FIRM, P.A., P.O. BOX 10827, GREENVILLE, SC, 29603-0827, US

(21) Appl. No.: 12/077,218

(22) Filed: Mar. 18, 2008

(30) Foreign Application Priority Data
Mar. 21, 2007 (DE) 102007013598.1

(51) Int. Cl. G02B 7/182; B01J 19/08; B29D 11/00

(52) U.S. Cl. 359/871; 427/457; 216/24; 264/1.37

(57) ABSTRACT

A mirror pane comprising a substrate of plastic having a front side and a rear side, each having a metal coating, and a surface heating apparatus with at least one resistance heating strip and electric connection contacts, wherein the metal coating placed on the front side of the substrate serves as a reflective mirror surface, and the at least one resistance heating strip possessing the electrical connection contacts is located within recesses in the rear side of the recesses reproducing a negative image of the at least one resistance heating strip and being furnished with connection contacts.

This invention is directed to a mirror pane with a substrate of plastic in to a method for the manufacture of the same and to an external mirror with such a mirror pane.

Mirror panes with a substrate of plastic, which have a reflective surface of an electrically deposited coating of chromium are already known. As a rule, such mirrors are provided with an applied surface heating foil, in which a heat conducting foil has been inserted between a carrier foil and a covering foil. In particular cases, it is also possible, to impress the heating conducting pathway directly upon the mirror pane itself. This method, however, is particularly expensive in the case of convex/concave mirror panes. Because of the relatively low weight of plastic substrate, as compared to glass, mirrors so equipped have an advantage of being of light weight. However, the manufacture thereof is considerably more expensive due to the cost of electrical deposition of chromium on the plastic in comparison to mirror panes which are entirely of glass. The result of this is that mirrors with conventional plastic substrates find service in only a few instances of special applications.

Thus, it is a purpose of the present invention to make available a mirror pane with a substrate of plastic, wherein the manufacturing costs thereof are considerably reduced in comparison to such mirrors conforming to the present state of the technology. Further, the purpose of the invention includes a method of manufacture, which corresponds to the making of the above described mirror pane. In addition, the invention encompasses the realization of an external mirror having such a mirror pane.

### SUMMARY OF THE INVENTION

The above objectives are accomplished according to the present invention as hereinafter set forth.

Because the heat conducting strip (or strips) of the surface heating apparatus is activated by resistance to electrical current and because one or more electrically deposited strips are on the plastic substrate, the expense engendered by the conventional foil based surface heating apparatus is eliminated. The invented surface heating apparatus now becomes much more an integral component of a metal layer on the back side of the plastic substrate. On the front side of the plastic substrate a metal layer serves as a reflectant mirror means.

The metal layer can be put in place, for example, by means of sputtering. Advantageously, the application of the plastic substrate is carried out by an electrically activated deposition. In the case of this electrical deposition onto plastic surfaces, in a first step, the surfaces are treated with an aggressive pickling solution so that they become more receptive to subsequent steps. Thereafter, the so pickled plastic surfaces are activated by palladium. The following step is the application of nickel by deposition without electrical intervention. This prepares the way for subsequent stratification with different metal coatings, namely, copper, nickel, chromium and the like, each or all of which can be electrically deposited.

By employing an advantageous feature of the invention, i.e. insulation, electrical short circuits are prevented when, in operational service, the invented mirror pane is subjected to sprayed water or exposed to other foreign materials.

The plastic substrate is provided with projections on its reverse side, which serve as retention means for the fastening of the mirror pane on a mirror holding plate and/or can serve as electrical connecting contacts for the surface heating apparatus.

These projections may be likewise electrically coated and so positioned on the rear side of the plastic substrate, that they lie on the resistance heating strip and serve as electrical contacts for the surface heating means.

The projections may be employed as fastening agents for affixing the mirror pane on a mirror holding plate. In this case, a metal coating is not necessary. In this case, the mirror plate may be mounted in a simplified manner on its holding plate.

The metal coating may be formed of a plurality of layers which have been electrically deposited on the mirror pane, first, serves as a reflecting layer for the mirror and second is a heating conductor for the surface heating apparatus. This plurality of layers can be comprised of a succession of various metals, or a plurality of a single metal, wherein the layers are deposited in repeated, separate steps. In this manner, it is possible to favorably alter the optical characteristics of the reflective mirror layer in a predetermined way. Furthermore, by means of a soft copper coating, random individual differences in coefficients of expansion by heat between the plastic substrate and the metal coating are compensated for.

The outer most coating may be chromium to optimize the reflective function of the mirror.

The electrical deposition of metal coating, which coating also serves as a reflective surface, completely covers the entire plastic substrate, insofar as other surfaces have not been similarly treated. In this way, what is visually a negative image of the resistance heating strip of the surface heating apparatus insulates in such a selective manner, that upon subjection to an electrical current no metal deposits itself thereon. Consequently, the surface heating apparatus can be fully exposed during the electrical deposition of the metal coating. Accordingly, the surface heating apparatus is electrically deposited simultaneously with the metal coating. Such a reduction in time and labor simplifies manufacturing and can be carried out at low cost.

The possibility also exists as an alternate, in that the surface of the plastic substrate can be completely coated at once, i.e., without the masking by insulation. In this case, the resistance heating strips to the surface heating system can be delineated following a deposition of metal coating wherein the interposed areas between the true resistance heating strips can be cleared of metal by mechanical machining.

Instead of the indicated mechanical machining, the metal removal can be made by pickling or by subjection to a laser beam.

### DESCRIPTION OF THE DRAWINGS

The invention will be more readily understood from a reading of the following specification and by reference to the accompanying drawings forming a part thereof, wherein an example of the invention is shown and wherein:

FIG. 1 is a plan view on the rear side of a first embodiment of the invention;

FIG. 2 is a sectional view along the line A-A of FIG. 1;

FIG. 3 is a detail from the presentation of FIG. 2;

FIG. 4 is a detailed view of the connection contact of the first embodiment;

FIG. 5 is a perspective view of a mirror pane from the front, in accord with a second embodiment of the invention, and

FIG. 6 is a presentation of the rear side of the mirror pane of FIG. 5.

### DESCRIPTION OF A PREFERRED EMBODIMENT

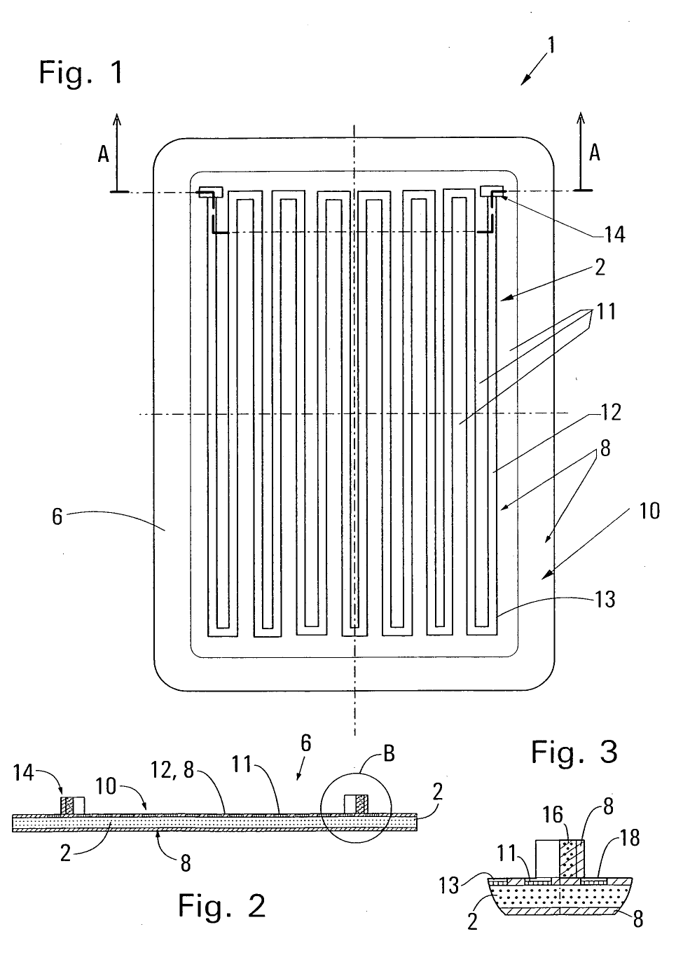

Referring now in more detail to the drawings, the invention will now be described in more detail. FIGS. 1 to 4 show a first exemplary embodiment of the invention relating to a planar mirror pane. The mirror pane is rectangular with rounded corners.

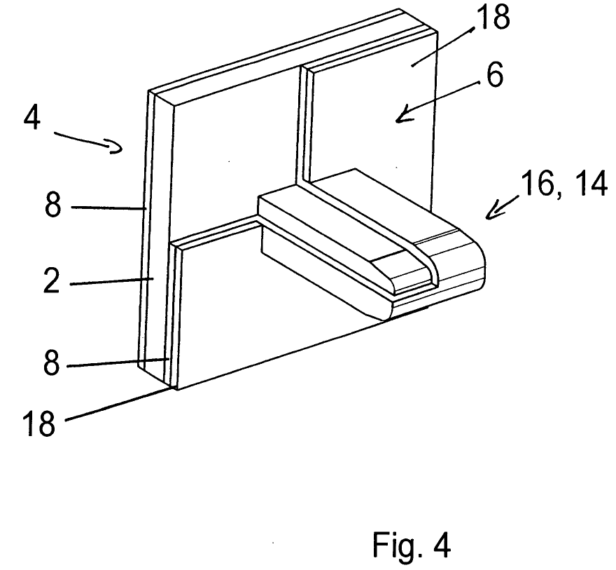

FIGS. 1 to 4 illustrate a first embodiment of a mirror pane 1 in accord with the present invention. The mirror pane 1, of the first embodiment, consists of a flat, plastic substrate 2 with a front side 4 and a rear side 6. The plastic substrate 2 is coated with an electrically deposited metal coat 8 on the front side 4 as well as on the rear side 6. This metal coating consists of a plurality of metal layers, wherein the outermost layer is a chromium coat which, serves on the front side 4 as the principal reflecting surface. On the rear side 6 of the plastic substrate, the electrical deposition procedure lays down on the plastic substrate 2 a surface heating apparatus 10 with a meandering, resistance heating strip 12 and two electrical connection contacts 14 which are integrally placed thereon. This integration of the surface heating apparatus 10, i.e., of the resistance heating strip 12 is made possible by the following procedure. Prior to the electric deposition of the metal coating 8 on the rear side 6 of the plastic substrate 2, the optically negative image of the resistance heating strip 12 is covered with an insulation material 11. This has the result that on this now covered surface area, no metal can be deposited by electrical deposition action. By means of the insulation material 11 there is created during the electrical deposition process, recesses 13 in the metal coating 8, which are filled with insulation material 11. The metal coating 8 of the meandering resistance heating strip 12 ends in two electrical connection contacts 14, with are formed by projections 16 on the rear side 6. These electrical contacts 14 are also covered with a metallic coating. Details of at least one projection 16, that is, one of the connection contacts 14, is presented in FIG. 4. In order to avoid short circuits, the resistance heating strips 12 are covered with an insulation layer 18.

The integral manufacture of the heating strip 12 on the rear side of the plastic substrate 2 can, as an alternative, also be effected, in that instead of an insulating coverage of the negative image of the resistance heating strip 12 along with the electrical connections 14, a treatment of the plastic substrate 2 can be carried out. This is done in such a way, that the appropriate surfaces repel the metal coating 8, so that metal free recesses 13 are formed which are partially free the plastic substrate 2 from metal.

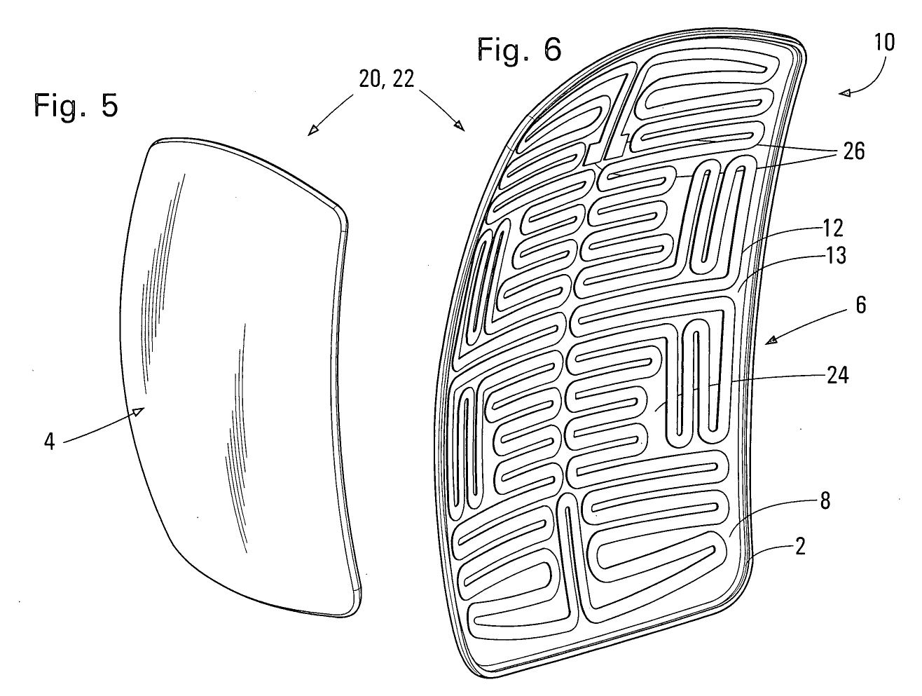

FIGS. 5, 6 show a second exemplary embodiment of the a mirror pane 20 with a plastic substrate 22, the front side 4 of which possesses a convex surface. FIG. 5 presents the front side 4 of the mirror pane 20 and FIG. 6 shows the rear side 6 with the surface heating apparatus 10 in the form of a meanderingly running heating strip 12. The meander shaped resistance heating strip 12 is so designed, that greater intervening spaces 24 are formed between the individual windings of the strip 12, which serve for the reception of (not shown) fastening elements. The metal coating 8 of the mirror pane 20 is, as in the case of the planar mirror pane, deposited electrically and also the surface heating apparatus 10 can be installed on the rear side 6 as has been previously described. The resistance heating strip 12 ends likewise in two electrical connection contacts 26 which, contrary to the contacts 14 of the first embodiment, are designed as flat contacts and not as projections.

Alternately, it is possible that the surface heating apparatus 10 is produced both for the first as well as the second embodiment, in that first the plastic substrate 2 is fully coated with metal on both sides 4, 6 and subsequently the metal coating 8, on the rear side 6 of the plastic substrate 2 is subsequently partially removed in accord with the negative image of the resistance heating strip 12.

While a preferred embodiment of the invention has been described using specific terms, such description is for illustrative purposes only, and it is to be understood that changes and variations may be made without departing from the spirit or scope of the following claims.

What is claimed is:

1. A mirror pane comprising:
a substrate of plastic having a front side and a rear side, each having a metal coating, and a surface heating apparatus with at least one resistance heating strip and electric connection contacts, wherein the metal coating placed on the front side of the substrate serves as a reflective mirror surface, and the at least one resistance heating strip possessing the electrical connection contacts is located within recesses in the rear side said recesses reproducing a negative image of the at least one resistance heating strip and being furnished with connection contacts.

2. A mirror pane in accord with claim 1, wherein the metal coating is an electrically deposited metal layer.

3. A mirror pane in accord with claim 1 wherein the resistance heating strip is covered with an insulation coating.

4. A mirror pane in accord with claim 1, wherein the rear side of the plastic substrate is provided with projections.

5. A mirror pane in accord with claim 4, wherein at least two of the projections are provided with the metal coating and form the electric connection contacts for the surface heating apparatus.

6. A mirror pane in accord with claim 4, wherein at least one of the projections is designed as a fastening element.

7. A mirror pane in accord with claim 1, wherein the metal coating consists of a plurality of coatings.

8. A mirror pane in accord with claim 7, wherein the outermost coating consists of chromium.

9. A mirror pane in accord with claim 1, wherein the at least one resistance heat strip is meandering in shape.

10. A method for the manufacture of a mirror pane having the following steps of operation:
providing a substrate of plastic with a front side and a rear side;
providing a negative image of at least one resistance heating strip with electrical connection contacts;
coating the rear side of the substrate in such a manner that no metal is deposited within the surface of said negative image; and
subjecting the plastic substrate to electrical deposition current so that the front side and the rear side of the substrate, with the exception of the negative images, receive a metal coating.

11. A method in accord with claim 10, wherein the treatment of the negative image of the at least one resistance heating strip includes covering of the negative image with insulation material.

12. A method for the manufacture of a mirror pane having the following steps of operation:
making available a substrate of plastic with a front side and a rear side having a negative image, receiving at least one resistance heating strip with electrical connection contacts;
subjecting the substrate to an electric deposition procedure, so that the front and the rear sides of the substrate receive a metal coating at least partially removing the metal coating on the rear side of the substrate from the negative image of the at least one resistance heating strip with electrical connection contacts.

13. A method in accord with claim 12, wherein the metal coating is removed by an appropriate etching solution.

14. A method in accord with claim 12, wherein the metal coating is removed by a laser beam.

15. A method in accord with claim 12, wherein:
an electrical insulation layer is installed over the at least one resistance heating strip.
